(19) United States
(12) Patent Application Publication
(10) Pub. No.: US 2002/0091055 A1
(43) Pub. Date: Jul. 11, 2002

(54) Device and method for ply-bonding tissue products and multi-ply tissue web

(76) Inventors: Ferdinand Hein, Mannheim (DE); Harald Harlacher, Mannheim (DE)

Correspondence Address: YOUNG & THOMPSON, 745 SOUTH 23RD STREET 2ND FLOOR, ARLINGTON, VA, 22202

(21) Appl. No.: 10/025,772

(22) Filed: Dec. 26, 2001

Related U.S. Application Data
(60) Provisional application No. 60/257,161, filed on Dec. 22, 2000.

(51) Int. Cl. B31F 1/20

(52) U.S. Cl. 493/463

(57) ABSTRACT

A device for ply-bonding tissue products comprising first conveying means for a first single/multi-ply tissue web; as well as a roll pairing (22, 30; 22, 28), one roll of which is an embossing roll (22; 28); and one of the two rolls (22; 28) has spikes (26) on the shell surface cooperating with a companion roll (30; 28; 22) of high rubber hardness. The two rolls are adapted in location and length of the spikes (26) so that the spikes perforate both the first tissue web (14) and the second tissue web (16) in the nip of the roll pairing.

### BACKGROUND OF THE INVENTION

1. Field of the Invention

The invention relates to a device and a method for ply-bonding multi-ply tissue products and a multi-ply tissue web.

2. Prior art

In processing multi-ply tissue products it is known to emboss the individual tissue plies to enhance We volume of the products composed of the plies, a distinction being made in this respect between nested embossing and foot-to-foot embossing.

Conventional nested embossing involves steel/rubber embossing requiring in each case the passage of a single/multi-ply tissue web between a rubber roll and a steel embossing roll having a shell with protuberances Glue is additionally applied in the region of one of the two embossing rolls. The two embossed tissue webs are married between an embossing roll and an additional rubber roll, the marrying roll, resulting in the plies being glued to each other. Nested embossing results only when the operation of the individual embossing rolls and guidance of the tissue webs to be joined together is set so that the protrusions of one tissue web nest in the hollows existing between the protrusions of the other tissue web.

In foot-to-foot embossing no marrying roll is used. The two single/multi-ply tissue webs to be joined are each embossed in the nip between a rubber roll and the embossing roll and glue applied to the plies at one of the two embossing rolls. The two embossing rolls are thus arranged relative to each other so that a nip is formed between the two embossing rolls in which the glued and a non-glued ply are nipped together so that the protrusions formed by embossing in the first tissue web come up against he protrusions in the second embossing tissue web.

In both cases conventional ply-bonding glue is employed to produce a ply-bonding, between the embossed tissue webs.

It is also known in prior art to ply-bond non-embossed tissue products by making use of a steel roll having small pointed protuberances, termed spikes in the following to distinguish them functionally from the conventional protuberances of an embossing roll. Ply-bonding is formed materializes by combining the steel roll with a rubber roll. Several non-embossed plies of tissue products are passed through the resulting nip whereby the plies are perforated by the spikes to thus produce a ply-bonding mechanism between the plies. However, this procedure fails to produce any appreciable increase in volume as in classic embossing, it merely producing a ply-bonding.

EP 0 796 728 A2 describes a device and a method for simultaneously embossing and bonding the tissue plies. Perforating elements are providing on two engaging embossing rolls, in the nip of which the two tissue webs are passed through. The perforating elements on the two embossing rolls engage in the nip to thus join the plies to each other.

### SUMMARY OF THE INVENTION

The invention is based on the object of proposing a device and a method for ply-bonding tissue products permitting, despite a simple configuration, high variability in embossing.

This object is achieved by a device having the features of claim I and by a method having the feature of claim 14. The multi-ply tissue web is characterized by the features of claim 19.

The gist of the invention is to employ a pair of rolls, one of which is an embossing roll and the other having a spiked shell surface, spikes being understood to be pointed protuberances. The spiked roll cooperates with a companion roll with a yielding surface, thus making it possible to adapt the position of the two rolls and the length of the spikes to each other as well as to the properties of the tissue webs so that the spikes perforate both the first tissue web and second tissue web simultaneously and penetrate to some extent into the companion roll.

Ply-bonding embossed tissue webs is thus achieved by perforating both the first and second tissue web with the spikes. Due to the embossed tissue webs being ply-bonded mechanically there is now no need for gluing whilst permitting both a foot-to-foot and nested configuration, whereby the ply-bonded tissue webs may be single-ply or multi-ply.

The gist of the method in accordance with the invention is that simultaneously with joining the first embossed tissue web and the second tissue web the spikes of the one roll perforate both tissue webs to contact each other for a mechanical tack,

Preferred embodiments of the invention are characterized by the remaining claims.

In accordance with one preferred embodiment of the invention the spiked roll is simultaneously the first embossing roll having spikes on the embossing protuberances. As detailed in the following description of the Figures his embodiment permits achieving both a foot-to-foot and nested embossing. In the nested arrangement it is furthermore preferred that the companion roll is a marrying roll forming a nip with the spiked embossing roll for joining the two tissue webs.

In accordance with an alternative preferred embodiment of the device including an embossing roll having spikes on the embossing protuberances it comprises furthermore a first rubber roll engaging the first spiked embossing roll for embossing and perforating a first single/multi-ply tissue web and a second embossing roll engaging a second rubber roll for embossing a second single/multi-ply tissue web. This configuration too is highly variable since both foot-to-foot and nested embossing is achievable simultaneously.

In accordance with a preferred alternative the spiked roll is a first embossing roll and the companion roll is a second embossing roll. This configuration permits foot-to-foot ply-bonding without glue being needed, in other words, the tissue webs to be joined to each other are in direct contact portionwise with no layer inbetween.

In the last-mentioned embodiment involving a pair of embossing rolls these comprise furthermore a first rubber roll engaging the first embossing roll for embossing and perforating a first single/multi-ply tissue web as well as a second embossing roll and a second rubber roll for embossing a second single/multi-ply tissue web, the first tissue web and the second tissue web being brought together so that foot-to-foot embossing and ply-bonding is formed with no glue layer between the first tissue web and second tissue web.

In accordance with a farther advantageous embodiment of the invention the spiked roll is a marrying roll and the other roll of the pair is a first embossing roll. This embodiment has the advantage that perforating the first and second tissue web occurs simultaneously in the nip between marrying roll and first embossing toil. The benefit in this case is that the first tissue web does not need to be guided first through the nip between a rubber roll and a spiked embossing roll before the first and second tissue web have been married. When the rubber roll, cooperating with the spiked embossing roll and forming the nip, is made of a rubber of insufficient hardness the material between the two rolls is not satisfactorily perforated, thus risking fault production. This risk can be offset by simultaneously perforating both tissue webs already in contact with each other In a further advantageous aspect of this embodiment a first rubber roll engages the first embossing roll for embossing a first single/multi-ply tissue web and a second rubber roll engages a second embossing roll for embossing a second single/multi-ply tissue web. The first embossing roll cooperates with the spiked marrying roll whilst the second embossing roll conveys the already embossed tissue web into the nip between the first embossing roll and the marrying roll.

In this arrangement it is possible to locate the first tissue web relative to the second tissue web so that a nested embossing is formed whereby direct contact exists between the first tissue web and second tissue web thus requiring no glue layer, i.e. there is only a mechanical ply-bonding.

In accordance with a preferred embodiment the rubber rolls have a Shore A hardness in the range 30 to 70 and preferably in the range 35 to 60.

Preferably the companion roll has a Shore A hardness in the range 60 to 100 and most preferably in the range 80 to 100.

In accordance with another preferred embodiment of the method in accordance with the invention the first and second tissue webs are simultaneously perforated so that the spikes are in contact with each other through both tissue webs. As already indicated above this is particularly of advantage in adapting to the best suitable hardness of the companion roll since this permits selecting the best suitable material pairing of the rolls cooperating with each other in each case for producing the embossings in the two tissue webs and for producing the mechanical ply-bonding by perforating the tissue webs.

Common to all embodiments is, in addition, that the perforation connection not only serves to produce the ply-bonding but may also act as a design breakpoint, i.e. by producing a perforation line, for example, so that individual sections of the web tissue material can be easily separated, as required for toilet paper or kitchen wipes.

The roll covered with spikes can be made of any material that can receive and hold the spikes. The roll itself can thus be made of synthetic polymers or rubber or ceramic. It has only to be ensured that the material of the spikes has a higher hardness than the material of the companion roll, so that a nip is formed between the spiked roll and the companion roll and the spikes penetrate into the softer material of the companion roll. The spikes could be made of steel or ceramic material, but also of synthetic materials like re-enforced glass fibres or hard rubber. The softer material of the companion roll has to be selected corresponding to the material of the spikes. For the companion roll, rubber, synthetic polymers or soft metals like copper alloys can be used.

Despite the fact that in the following detailed description of preferred embodiments to separate conveying means for the first and the second single or multi-ply tissue web will be described respectively, it should be noted that it is possible to use only a single conveying means for one multi-ply tissue web. The plies of this multi-ply tissue web can be separated into different individual webs comprising one or more tissue plies, before the inventive method starts. Another possibility is to keep together supplies of a multi-ply web and to treat the multi-ply tissue web first in an embossing nip and at the same time form the ply-bonding with spikes or to carry out the ply bonding in an additional, second nip.

Finally, it is possible to join more than two tissue webs (multi-ply or not) with the inventive method. Additional web could be sandwiched between the first and second web and could either be embossed or not embossed.

The inventive multi-ply tissue web comprises a first single ply or multi-ply tissue web and at least a second single ply or multi-ply tissue web. It is characterized in that the ply bonding between the first tissue web an the at least one second tissue web is performed by perforating both the first and the second tissue web through some protrusions of one of the tissue webs. In this respect, at least one of the second tissue webs can be not embossed or two tissue webs are bonded which are both embossed. In the last mentioned case both a nested configuration and a foot-to-foot-configuration can be formed.

According a preferred embodiment of the invention the perforating protrusions formed by the perforation project outwardly over one of the main planes of the multi-ply tissue web. The main planes of the tissue-web which will be discussed later in the context of FIG. 4 of the preferred embodiments, form the envelope of the multi-ply tissue web without considering the perforating protrusions formed by the perforations. Since the perforating protrusions project outwardly over one of the main planes of the multi-ply tissue web, a product is formed which is two-sided i.e. both sides of the resulting multi-ply tissue web give a different impression to the user. If this is not desired, it is possible according to an alternative embodiment to form the multi-ply tissue web in a way so that the perforating protrusions formed by the perforations are situated in depressions formed between the embossing protrusions and, thus, do not project over one of the main planes.

### BRIEF DESCRIPTION OF THE DRAWINGS

The invention will now be detailed purely by way of example with reference to the attached Figures in which:

FIG. 1 is a schematic view of a first embodiment of a device in accordance with the invention;

FIG. 2 is a side view of a spiked embossing protuberance;

FIG. 3 is a schematic view of a second embodiment of a device in accordance with the invention;

FIG. 4 is an illustration of an embossing pattern of a tissue web produced by the device as shown in FIG. 1;

FIG. 5 is an illustration of an embossing pattern of a tissue web produced by the device as shown in FIG. 3;

FIG. 6 is a schematic view of a third embodiment of a device in accordance with the invention;

FIG. 7 is an illustration of a embossing pattern of a tissue web produced by the device as shown in FIG. 6.

### DETAILED DESCRIPTION OF PREFERRED EMBODIMENTS

It is to be noted that like components and identified by like reference numerals in the following description with reference to the Figures.

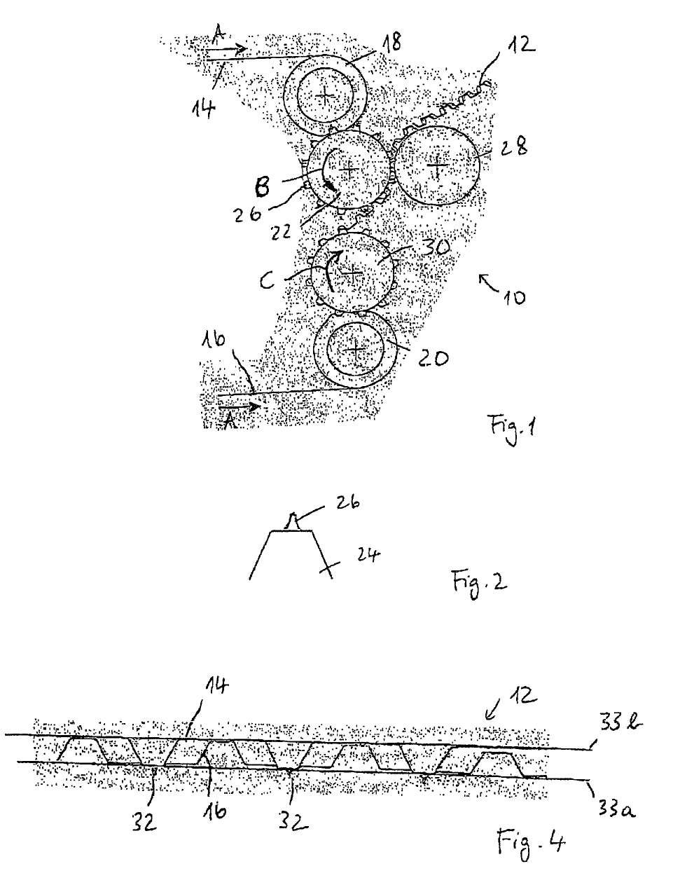

Referring now to FIG. 1 there is illustrated a first embodiment of the invention illustrating only the parts of the device as needed to understand the invention. In the device 10 as shown schematically a tissue web 12 is produced from a first single/multi-ply tissue web 14 and a second single/multi-ply tissue web 16. The tissue webs 14 and 16 are continuously guided in the direction of the arrow A about a first rubber roll 18 and second rubber roll 20 respectively. Each rubber roll, like each of the other rolls as described in the following is rotatable about its cylindrical longitudinal centerline as powered by a drive system (not shown) and as regards its length adapted to the web width of the first a second tissue web. The first rubber roll 18 as well as the second rubber roll 20 have a rubber hardness in the range of approx. 30 to 70 Shore A and preferably in the range of 35 to 65 Shore A.

As evident from FIG. 1 the first tissue web 14 is guided around the first rubber roll and through the nip between the first rubber roll 18 and a first embossing Toll 22. The first embossing roll 22 has a high hardness and may be made of steel, for example. Provided on the cylindrical shell surface of the first embossing roll 22 are embossing protuberances 24 as shown in FIG. 2 schematically. The embossing protuberances 24 are topped by additional protuberances 26 termed spikes in the framework of this description. .Due to the cooperation of the first rubber roll with the first embossing roll 22 the first tissue material guided through the nip between the first rubber roll 18 and first embossing roll 22 is not only embossed but also perforated in the region of the spikes 26. Due to the first embossing roll 22 turning in the direction of rotation B the tissue material located thereon and perforated by the spikes is delivered in the direction of rotation B and supplied to a nip between the first embossing roll 22 and a marrying roll 28. The marrying roll is made of a material having a high rubber hardness of 60 to 100 Shore A and a preferably approx 80 Shore A and serves to marry the perforated first tissue web 14 to the second tissue web 16 as described in the following.

The second tissue web 16 is guided about the second rubber roll 20 and through the nip between the second rubber roll 20 and second embossing roll 30. The direction of rotation C of the second embossing roll 30 is opposite to the direction of rotation B of the first embossing roll 22. The embossed second tissue web leaving the second embossing roll is supplied to the nip between the spiked first embossing roll 22 and the marrying roll 28. In this arrangement each of the rolls is controlled via a drive system so that the first tissue web 14 and the second tissue web 16 are married nested in the nip between the first embossing roll and the marrying roll. In the nip between the first embossing roll 22 and marrying roll 28 the embossed second tissue web 16 is also perforated by the spikes 26, resulting in a ply-bonding between the first tissue web and the second tissue web. It is this mechanically produced ply-bonding that eliminates the need of a gluing station.

In the embodiment as shown it is the actual embossing protrusion that handle the ask of increasing the volume of the tissue webs whilst the spikes 26 topping the first embossing roll 22 in conjunction with the marrying roll serve to produce the ply-bonding. The requirement for this is that the marrying roll has a sufficiently high rubber hardness, as described above. Fox this reason it may happen that in the device as shown in FIG. 1 the first tissue web 14 is still to be fully perforated in the nip between the first rubber roll 18 and the first embossing roll 22, whereas as shown in FIG. 2 complete perforation of the first tissue web occurs simultaneously with perforation of the second tissue web in the nip between the first embossing roll 22 and the marrying roll 28 so that any still incomplete perforation of the first tissue web in the nip between the rolls 18 and 22 is corrected as follows.

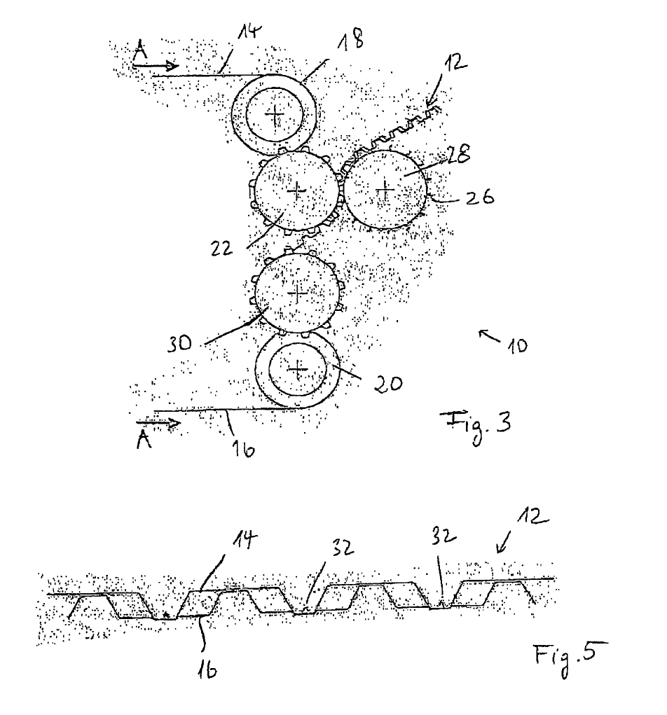

Referring now to FIG. 3 there is illustrated a further embodiment of the invention, the parts of which correspond substantially to those as already explained with reference to FIG. 1. One substantial difference lies in the fact that the first embossing roll 22 has embossing protuberances 24 but not topped by spikes, Instead of this the marrying roll 28 is providing with spikes 26. The first embossing roll 22 is in addition made of a material having a high rubber hardness, preferably exceeding 80 Shore A. Unlike the example embodiment as shown in FIG. 1 the first embossing roll 22 is thus made of a plastics material whereas the marrying roll 28 is a spiked roll, e.g. a steel roll, the spikes of which are arranged so that they prick the embossing protrusions and thus produce the desired ply-bonding in a nested embossing between the first tissue web 14 and the second tissue web 16. The first rubber roll 18 and second rubber roll 20 have a conventional rubber hardness in the range 30 to 70 Shore A and preferably 35 to 65 Shore A so that with this roll combination between the first rubber roll 18 and the first embossing roll 22 the result is similar to that of a conventional steel/rubber embossing as, for example, between the second rubber roll 20 and the second embossing roll 30.

Another difference between the nested embossings as shown in FIG. 1 and FIG. 3 is that in the embodiment as shown in FIG. 3 both the first tissue ply and also the second tissue ply are perforated by the spikes 26 simultaneously.

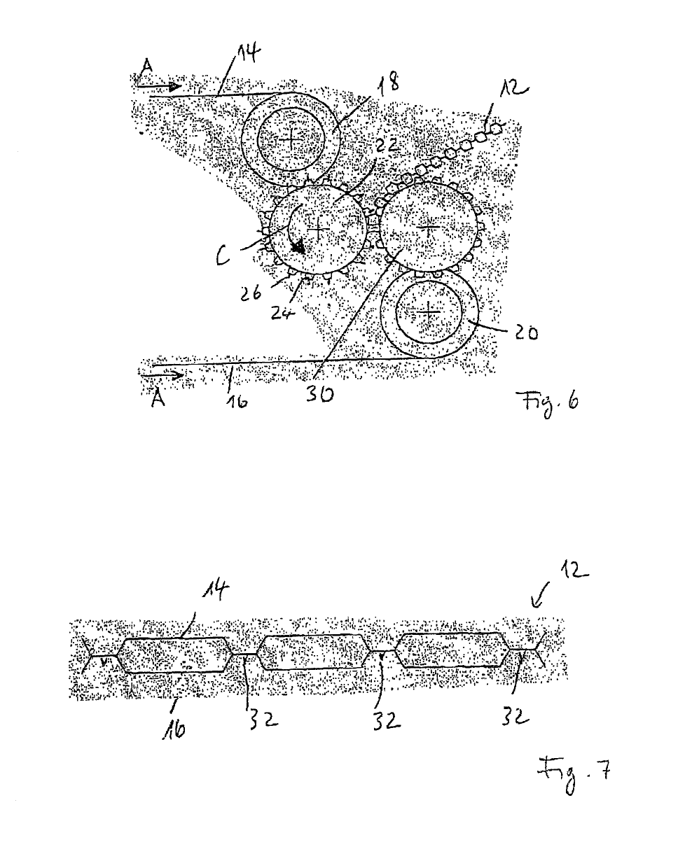

A further difference lies in the resulting embossing patterns as shown in FIG. 4 for a device as shown in FIG. 1 and as shown in FIG. 5 for a device as shown in FIG. 3. In both cases a nested embossing is involved, the wipe comprising one-sided perforating protrusions 32 as shown in FIG. 4 formed by the penetration, i.e. the perforation of the spikes. The single sided perforating protrusions 32 project over the main plane 33a of the multi-ply tissue web. A main plane 33a, 33b of the tissue web is to be understood as that enveloping plane of the joint product of the first single or multi-ply tissue web and the at least one second single or multi-ply tissue web, wherein the perforating protrusions formed by perforating the tissue webs are not considered. This means that only the bonding of the tissue plies to a tissue web has to be considered but not the mechanical generation of the ply bonding which is carried out in a subsequent process step or at the same time. In the embodiment according to FIG. 4, the perforating protrusions 32 formed by the perforations project over the main plane 33a of the multi-ply tissue web. The resulting product is thus two-sided, i.e. both sides of the resulting wipe give a different impression to the user.

The perforating protrusion 32 in the ripe whose embossing configuration is shown in FIG. 5 and produced on a device as shown in FIG. 3 extend into the interior of the wipe, thus resulting in the two-sided effect being significantly less. Accordingly, as regards its two main surfaces a more homogenous product can be produced with the device as shown in FIG. 3.

Referring now to FIG. 6 there is illustrated yet another embodiment of the invention which differs from the embodiments as described hitherto in that a foot-to-foot embossing is implemented. The first tissue web 14 is guided about the first rubber roll 18 and about a first embossing roll 22 whose embossing protuberances are topped with spikes 26. The second tissue web 16 is guided around a second rubber roll 20 and is embossed in the nip between the second rubber roll and a second embossing roll 30. The spiked first embossing roll 22 and the second embossing roll engage to join the first tissue web to the second tissue web. The movements of the first embossing roll 22 and second embossing roll 30 are adapted so that foot-to-foot embossing is formed. At the same time the spikes 26 topping the protuberances of the first embossing roll perforate the tissue webs in contact with each other in the region of the protrusions to produce the desired ply-bonding, no glue application being required for this mechanically produced ply-bonding. The ply-bonding of the two tissue webs occurs between the second embossing roll 30 e.g. of a hard plastics material, having a Shore A hardness of 60 to 100 and preferably 80 to 100, and the spiked first embossing roll 22 of steel. Embossing the individual tissue webs 14 and 16 is done between the first rubber roll 18 and first embossing roll 22 as well as between the second rubber roll 20 and the second embossing roll 30, here too the material pairing between the hard plastics material of the second embossing roll 30 and the rubber of the second rubber roll 20 having a Share A hardness in the range 30 to 70 and preferably 35 to 65 being sufficient to achieve a similar result in embossing as is known for conventional steel/rubber embossing.

Referring now to FIG. 7 there is illustrated schematically the embossing pattern formed by for the device as shown in FIG. 6 with a typical foot-to-foot embossing whereby in the portions in which the first tissue web 14 and the second tissue web 16 are in direct contact with each other the perforating protrusions 32 are evident from perforation of the first and second tissue web.

Common to all of the embodiments as shown above is that a roll pairing for foot-to-foot or nested embossing of the first and second pre-embossed tissue webs is providing comprising a steel spiked roll and a cooperating roll of bard plastics material having a Shore A hardness in the range 60 to 100 and preferably in the range 80 to 100. At the same time one of the two rolls of the pair corresponds to an embossing roll which in cooperation with a rubber roll pre-embosses the tissue web as desired.

The pairing of a steel spiked roll with a cooperating roll of hard plastics material and rubber rolls permits by very simple ways and means variable embossing patterns as well as a ply-bonding to be achieved in eliminating the need for gluing to produce the ply-bonding. The spikes an one of the two rolls of the cooperating roll pair are sufficiently dimensioned to extend through the two individual supplied tissue webs prior to discharge of the embossed tissue web.

1. A device for ply-tacking tissue products comprising:
first conveying means for a first single/multi-ply tissue web;
a roll pairing (22, 30; 22, 28),
one roll of which is an embossing roll (22; 28), and
one of said two rolls (22; 28) has spikes (26) on the shell surface cooperating with a companion roll (30; 28; 22) of rubber hardness, wherein
said two rolls are adapted in location and length of said spikes (26) so that said spikes (26) perforate both said first tissue web (14) and said second tissue web ( 16) in the nip of said roll pairing.

2. The device as set forth in claim 1, further comprising:
second conveying means for a second single/multi-ply tissue web

3. The device as set forth in claim 1 or claim 2, characterized in that said spiked roll (22) is simultaneously a first embossing Toll (22) having spikes topping the embossing protuberances (24).

4. The device as set forth in claim 3, characterized in that said companion roll is a marrying roll (28).

5. The device as set forth in claim 3 furthermore comprising a first rubber roll (18) engaging said first embossing roll having spikes (26) for embossing and perforating a first single/multi-ply tissue web (14); and a second embossing roll (30) engaging a second rubber roll (20) for embossing a second single/multi-ply tissue web (16).

6. The device as set forth in claim 5, characterized in that said first tissue web (14) and said second tissue web (16) are located relative to each other so that a nested embossing is formed, wherein there is only-a mechanical ply-banding between said first tissue web (14) and said second tissue web (16).

7. The device as set forth in claim 3, characterized in that said companion roll is a second embossing roll (30).

8. The device as set forth in claim 7, furthermore comprising:
a first rubber roll (18) engaging said first embossing roll (22) for embossing and perforating a first single/multi-ply tissue web (14); and
a second rubber roll (20) engaging said second embossing roll (30) for embossing and perforating a second single/multi-ply tissue web (16),
said first tissue web (14) and said second tissue web (16) being located relative to each other so that a foot-to-foot embossing is formed and no glue layer exists between said first tissue web (14) and second tissue web (16).

9. The device as set forth in claim 1, characterized in that said spiked roll (26) is a marrying roll (28) and the other roll of said roll pairing is a first embossing roll (22).

10. The device as set forth in claim 9, furthermore comprising:
a first rubber roll (18) engaging said first embossing roll (22) for embossing
a first single/multi-ply tissue web (14); and
a second rubber roll (20) engaging a second embossing roll (30) for embossing a second single/multi-ply tissue web (16).

11. The device as set forth in claim 10, characterized in that said first tissue web (14) and said second tissue web (16) are married so that a nested embossing is formed and no glue layer exists between said first tissue web (14) and second tissue web (16).

12. The device as set forth in any of the claims 5, 6, 8, 10 or 11, characterized in that said rubber tolls have a Shore A hardness in the range of approx. 30 to 70 and preferably approx. 35 to 65.

13. The device as set forth in claim 1 and/or 12, characterized in that said companion roll has a Shore A hardness in the range 60 to 100 and preferably in the range 80 to 100.

14. A method for ply-tacking multi-ply tissue products comprising the steps:
(a) embossing a first single/multi-ply tissue web; and
(b) marrying said first tissue web and a said second single/multi-ply tissue web into a married tissue web and simultaneously
(c) mechanically perforating at least said second tissue web with a spiked roll so that spikes extend through both tissue webs and form a ply-bonding;
(d) discharging said married tissue web.

15. The method as set fort in claim 14, further comprising the step:
embossing the second single/multi-ply tissue web.

16. The method as set forth in claim 14 or 15 furthermore comprising simultaneously perforating said first tissue web in step (c).

17. The method as set forth in any of the claims 14 to 16, characterized in that said two embossed tissue webs of said married tissue web have a nested configuration.

18. The method as set forth in any of the claims 13 to 16, characterized in that said two embossed tissue webs of said married tissue web have a foot-to-foot configuration.

19. Multi-ply tissue web, comprising.
at first single-ply or multi-ply tissue web, and
at least one second single-ply or multi-ply tissue web,
characterized in that the ply-bonding between the first tissue web and the at least one second tissue web is formed by perforations through both the first tissue web and the second tissue web passing through some protrusions of one of the tissue webs.

20. Multi-ply tissue web as set forth in claim 19, characterized in that at least one of the second tissue webs is not embossed.

21. Multi-ply tissue web as set forth in claim 19, characterized in that the first tissue web and the second tissue web are embossed and bonded in a nested configuration.

22. Multi-ply tissue web as set forth in claim 19, characterized in that the first tissue web and the second tissue web are embossed and bonded in a foot-to-foot configuration.

23. Multi-ply tissue web as set forth in claim 19 or 20, characterized in that the perforating protrusions formed by the perforations are situated in depressions formed between the embossing protrusions.

24. Multi-ply tissue web as set forth in claim 19 or 20, characterized in that the perforating protrusion formed by the perforations project outwardly over one of the main planes of the multi-ply tissue web.
